(19) United States
(12) Patent Application Publication
(10) Pub. No.: US 2023/0227631 A1
(43) Pub. Date: Jul. 20, 2023

(54) HIGH-PERFORMANCE MATERIALS INCLUDING POLYMERS AND HYBRID NANOADDITIVES

(71) Applicant: MITO Material Solutions, Inc., Indiana, IN (US)

(72) Inventors: Kevin Keith, Carmel, IN (US); Bhishma Sedai, Stillwater, OK (US)

(21) Appl. No.: 18/010,379

(22) PCT Filed: Jun. 15, 2021
(86) PCT No.: PCT/US2021/037421

§ 371 Date: Dec. 14, 2022

Related U.S. Application Data
(60) Provisional application No. 63/038,976, filed on Jun. 15, 2020.

(51) Int. Cl. C08K 5/549; C08J 3/22

(52) U.S. Cl. CPC C08K 5/549; C08J 3/226; C08K 2201/011; C08K 2201/005; C08J 2363/00; C08J 2377/06

(57) ABSTRACT

A high-performance composite material is provided including a polymer and a hybrid nanoadditive dispersed throughout the polymer at a low concentration and without agglomeration. The hybrid nanoadditive includes a first, graphene oxide portion and a second, polyhedral oligomeric silesquioxane (POSS) portion. Associated extrusion systems and methods are also provided.

### CROSS REFERENCE TO RELATED APPLICATION

This application claims priority to U.S. Provisional Patent Application Ser. No. 63/038,976, filed Jun. 15, 2020, the disclosure of which is hereby expressly incorporated by reference herein in its entirety.

### STATEMENT REGARDING FEDERALLY SPONSORED RESEARCH OR DEVELOPMENT

This invention was made with government support under Contract No. 1926906 awarded by the National Science Foundation (NSF) Small Business Innovation Research (SBIR) program. The government has certain rights in the invention.

### FIELD OF THE DISCLOSURE

The present disclosure relates to high-performance materials. More particularly, the present disclosure relates to high-performance materials including polymers and hybrid nanoadditives and associated systems and methods.

### BACKGROUND OF THE DISCLOSURE

Nanoadditives for improving the mechanical properties of thermoset composite materials have received much attention in recent years. Such nanoadditives include polyhedral oligomeric silsesquioxane (POSS), which are silica-based nanostructures with the empirical formula RSiO_{1.5}, where R may be a hydrogen atom or an organic functional group, such as alkyl, acrylate, hydroxide, or epoxide unit.

There is a need for nanoadditives capable of being synthesized, stored, transported, and incorporated into composite materials on a commercial scale. There is also a need for nanoadditives capable of being incorporated into a wide variety of polymers, including thermoplastics. For example, U.S. Pat. No. 10,011,706 discloses POSS nanoadditives suitable for use in thermoset materials, specifically epoxy resins, ester-based resins (e.g., vinyl ester or cyanate ester), and bismaleimide (BMI) (Col. 7, Lines 38-41). However, it has been a challenge to find nanoadditives capable of dispersing through and improving mechanical properties of thermoplastic materials, in particular.

### SUMMARY

The present disclosure provides a high-performance composite material including a polymer and a hybrid nanoadditive dispersed throughout the polymer at a low concentration and without agglomeration. The hybrid nanoadditive includes a first, graphene oxide portion and a second, polyhedral oligomeric silesquioxane (POSS) portion. The present disclosure also provides associated extrusion systems and methods.

According to an embodiment of the present disclosure, a composite material is provided including a thermoplastic polymer and a hybrid nanoadditive including a first, graphene oxide portion and a second, POSS portion, wherein the hybrid nanoadditive is present in the thermoplastic polymer at a concentration of about 1.0 wt. % or less.

According to another embodiment of the present disclosure, a method is provided for manufacturing a composite material. The method includes extruding a thermoplastic polymer with about 1.0 wt. % or less of a hybrid nanoadditive, the hybrid nanoadditive including a first, graphene oxide portion and a second, POSS portion.

According to yet another embodiment of the present disclosure, a method is provided for manufacturing a hybrid nanoadditive for use in a composite material. The method includes reacting a functionalized graphene oxide with a functionalized polyhedral oligomeric silesquioxane (POSS) to form a hybrid nanoadditive, and processing the hybrid nanoadditive into a substantially uniform powder.

### BRIEF DESCRIPTION OF THE DRAWINGS

The above-mentioned and other features and advantages of this disclosure, and the manner of attaining them, will become more apparent and will be better understood by reference to the following description of embodiments of the invention taken in conjunction with the accompanying drawings, wherein:

FIG. 1 is a schematic view of an exemplary composite material of the present disclosure including one or more polymers, one or more hybrid nanoadditives, and optional reinforcing fillers;

FIG. 2 shows an exemplary hybrid nanoadditive including an amine-functionalized graphene oxide portion and a glycidyl POSS portion;

FIG. 3 is a flow chart of an exemplary method for synthesizing the hybrid nanoadditive;

FIG. 4 is a schematic view of an exemplary system for manufacturing the composite material of FIG. 1;

FIGS. 5A-5C are magnified images of dispersions prepared in accordance with Example 2;

FIG. 6 is a graph of IZOD notched impact test results in accordance with Example 3;

FIG. 7 is a graph of IZOD unnotched impact test results in accordance with Example 3;

FIG. 8 is a graph of tensile modulus test results in accordance with Example 3;

FIG. 9 is a graph of tensile strength test results in accordance with Example 3; and

FIG. 10 is a graph of tensile elongation test results in accordance with Example 3.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

### I. Composite Material

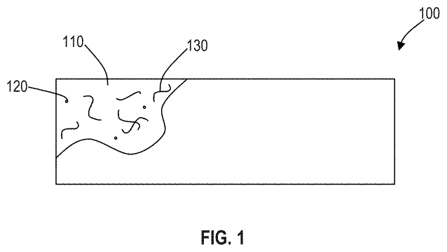

FIG. 1 is a schematic representation of an exemplary composite material 100 of the present disclosure. The material 100 has superior performance, flexibility, and durability. The material 100 also has superior toughness, allowing manufacturers the ability to make lighter or tougher parts, thereby reducing the likelihood of mechanical failure. The material 100 may be suitable for use in various industries, including transportation, marine, aerospace, consumer goods, energy, and other industries.

The material 100 includes one or more polymers 110, one or more hybrid nanoadditives 120, and optional reinforcing fillers 130. Each component of the material 100 is described further below.

### II. Polymer

In certain embodiments, the polymer 110 of FIG. 1 may be a widely available thermoplastic. Exemplary polymers 110 include thermoplastic polyamides such as nylon, more specifically nylon 66. Other exemplary polymers 110 include thermoplastic polyaryl ether ketones (PAEK), such as polyether ether ketone (PEEK), and thermoplastic polyesters, such as polyethylene terephthalate (PET). The polymer 110 may be a homopolymer or a copolymer of two or more different types of monomers. The polymer 110 may also be extrudable, as described further below.

In other embodiments, the polymer 110 of FIG. 1 may be a common industrial thermoset resin. Such resins include epoxy resins (e.g., bisphenol A, bisphenol F), ester-based resins (e.g., polyester, vinyl ester, cyanate ester), polyurethane resins, and bismaleimide (BMI), for example.

### III. Hybrid Nanoadditive

Referring still to FIG. 1, the hybrid nanoadditive 120 may be dispersed throughout the polymer 110 at a low concentration. In certain embodiments, the hybrid nanoadditive 120 may be present in the polymer 110 at a concentration of about 1.0 wt. % or less (not including any reinforcing filler 130), more specifically about 0.05 wt. % to about 1.0 wt. %, more specifically about 0.05 wt. % to about 0.75 wt. %, more specifically about 0.05 wt. % to about 0.5 wt. %, more specifically about 0.05 wt. % to about 0.25 wt. %., or more specifically about 0.1 wt. %. At a concentration of 0.1 wt. %, for example, 1 metric ton (1,000 kg) of the material 100 may be produced by combining 999 kg of the polymer 110 with only 1 kg of the hybrid nanoadditive 120.

The hybrid nanoadditive 120 may also be dispersed throughout the polymer 110 with minimal agglomeration. Before being incorporated into the polymer 110, the hybrid nanoadditive 120 may be present in powdered form, as described further below. The powdered, hybrid nanoadditive 120 may have a number-based average lateral dimension of about 40 microns or less, more specifically about 10 microns to about 35 microns, and a number-based average thickness of about 0.01 micron or less, more specifically about 0.0003 micron (0.3 nm) to about 0.001 micron (1 nm). The powdered, hybrid nanoadditive 120 may be substantially uniform in size, meaning that about 80%, about 90%, or more of the particles may have the lateral dimension of about 40 microns or less. After being incorporated into the polymer 110, the hybrid nanoadditive 120 may have a number-based average particle size of about 50 microns or less, more specifically about 15 microns to about 45 microns, more specifically about 20 microns to about 40 microns. Thus, the hybrid nanoadditive 120 may substantially retain its particle size before and after being incorporated into the polymer 110, at least in the lateral dimension.

The hybrid nanoadditive 120 includes a first, graphene oxide (GO) portion and a second, polyhedral oligomeric silesquioxane (POSS) portion. The graphene oxide portion may include one or more reactive moieties, and the POSS portion may include one or more reactive moieties capable of reacting with the graphene oxide moieties. These reactive moieties may include epoxides, alcohols, carboxylic acids, acrylates, isocyanates, ammonium groups, or other reactive functional groups. The reactive moieties may not completely react, such that some moieties on the graphene oxide portion and/or the POSS portion may remain free and unreacted to interact with the polymer 110.

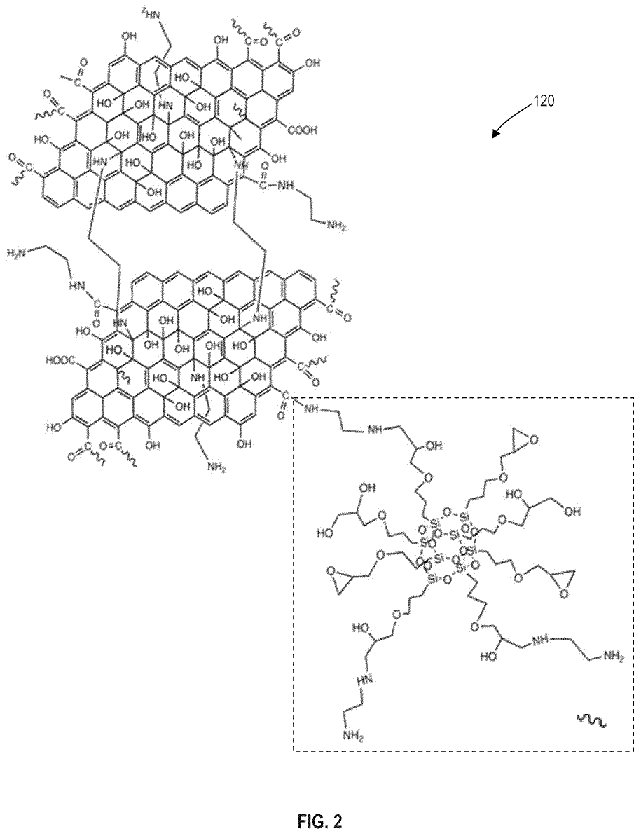

An exemplary hybrid nanoadditive 120 is shown in FIG. 2, where the first portion is amine-functionalized graphene oxide and the second portion is epoxide-functionalized POSS, specifically glycidyl POSS, more specifically a glycidyl POSS cage mixture (e.g., EP0409 available from Hybrid Plastics Inc. of Hattiesburg, Miss.). In this embodiment, one or more epoxide moieties of the POSS portion have reacted with amine moieties of the graphene oxide portion.

Other exemplary POSS portions for the hybrid nanoadditive 120 are provided in Table 1 below.

TABLE 1

| Reactive Moiety | Examples |
|---|---|
| Epoxy groups | Epoxycyclohexyllsobutyl POSS |
| | Epoxycyclohexyl POSS Cage Mixture (EP0408) |
| | Glycidyl POSS Cage Mixture (EP0409) |
| | Glycidyllsobutyl POSS |
| | Triglycidyllsobutyl POSS |
| | Octa Epoxycyclohexyl dimethylsilyl POSS |
| | Octa Glycidyldimethylsilyl POSS |
| | Bisphenol A Diglycidyl Ether POSS |
| Carboxylic acids | Octa Maleamic Acid POSS |
| | Maleamic Acid-Isobutyl POSS |
| Acrylo groups | Acrylolsobutyl POSS |
| | Acrylo POSS Cage Mixture |
| Methacrylate groups | Methacrylolsobutyl POSS |
| | Methacrylate Isobutyl POSS |
| | Methacrylate Ethyl POSS |
| | Methacryl Ethyl POSS |
| | Methacryl POSS Cage Mixture |
| | Methacryllsooctyl POSS |
| | Methacrylate Isooctyl POSS |
| Ammonium groups | Octa-ammonium POSS |

The hybrid nanoadditive 120 may be amphiphilic in nature and capable of separating, dispersing, and chemically cross-linking with various polymers 110. For example, the amphiphilic properties may be attributed to the various reactive groups like amine groups, hydroxyl groups, and/or epoxide groups on the C═C backbone of the graphene oxide portion. The cross-links may be evidenced by a rise in glass transition temperature (e.g., up to 6° C.) of composites containing the hybrid nanoadditive 120, even at very low concentrations (e.g., 0.1 wt. %) of the hybrid nanoadditive 120.

The hybrid nanoadditive 120 may also interact with not only the polymer 110, but also any aromatic moieties in the polymer resin system. Without wishing to be bound by theory, the present inventors believe that the graphene oxide portion may exhibit 7C-7C interactions with such aromatic moieties, such as hollow stacking, bridge stacking, and/or A-B stacking. These aromatic interactions may supplement the above-described chemical cross-linking with the polymer 110. Even within the same category of polymer resins systems, there may be significant differences in aromatic contents. For example, the INF-212 Slow Infusion Hardener epoxy resin from PRO-SET of Bay City, Mich. has a low aromatic content of about 1-5%, whereas the EPON 862 Liquid Epoxy Resin from Miller-Stephenson of Danbury, Conn. contains a hardener with an aromatic content of 35%. The hybrid nanoadditive 120 of the present disclosure has been shown to interact with various polymer resin systems (See Example 2 below).

The hybrid nanoadditive 120 may also possess the building blocks of epoxy thermoset chemistry (i.e., the amine-functionalized graphene oxide and the epoxide-functionalized POSS). Surprisingly, however, the hybrid nanoadditive 120 may be readily incorporable and dispersible in various polymers 110 (FIG. 1), whether thermoplastic or thermoset. In the context of a polyamide polymer 110, for example, and without wishing to be bound by theory, it is believed that one or more epoxide moieties of the POSS portion of the hybrid nanoadditive 120 may react with amine moieties of the polyamide polymer 110.

It is within the scope of the present disclosure to provide different hybrid nanoadditives 120 in combination. For example, the material 100 may include the hybrid nanoadditive 120 of FIG. 2 and/or other hybrid nanoadditives 120 having different graphene oxide portions and/or different POSS portions.

Additional information regarding the hybrid nanoadditive 120 may be found in U.S. Pat. No. 10,011,706, the entire disclosure of which is expressly incorporated herein by reference

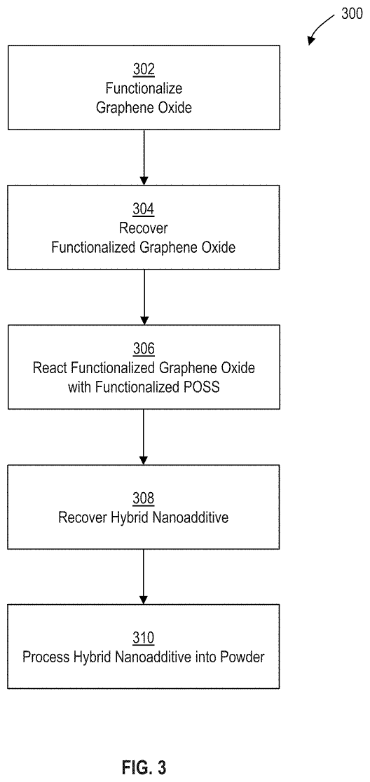

The hybrid nanoadditive 120 may be synthesized by a multi-step process 300, as shown in FIG. 3.

First, during a functionalizing step 302 of process 300, graphene oxide is functionalized with one or more reactive moieties. With reference to the hybrid nanoadditive 120 of FIG. 2, for example, graphene oxide may be converted to amine-functionalized graphene oxide by reacting graphene oxide in water with a water-soluble amine, such as ethylene diamine. Other exemplary water-soluble amines include, but are not limited to, 1,3-diaminopropane, 1,4-diaminobutane, 1,5-pentanediamine, [3-(aminomethyl)phenyl] methanamine, diethylenetriamine, triethylenetetramine, or butane-1,1,4,4-tetraamine. This functionalizing step 302 may involve mixing the ingredients at room temperature for a suitable period of time, such as 1 to 10 hours, more specifically 2 to 5 hours. The present inventors have discovered that it may be unnecessary to heat and reflux the ingredients with ultrasonication during this functionalizing step 302, contrary to the above-incorporated U.S. Pat. No. 10,011,706.

Second, during step 304 of process 300, the functionalized graphene oxide is recovered. This recovering step 304 may involve filtering the reaction mixture from step 302 and collecting the functionalized graphene oxide as the filtration cake.

Third, during step 306 of process 300, the functionalized graphene oxide from step 304 reacts with one or more reactive moieties of the functionalized POSS to form the hybrid nanoadditive. With reference to the hybrid nanoadditive 120 of FIG. 2, for example, one or more amine moieties of the amine-functionalized graphene oxide may react with one or more epoxide moieties of glycidyl POSS by dispersing the amine-functionalized graphene oxide from step 304 in an organic solvent (e.g., tetrahydrofuran, dimethyl sulfoxide), adding glycidyl POSS, and adding a suitable catalyst (e.g., N, N′-dicyclohexylcarbodiimide (DCC), aluminum triflate). This reacting step 306 may involve refluxing the ingredients at a suitable temperature, such as about 70° C. or more, for a suitable period of time, such as 1 to 10 hours, more specifically 2 to 5 hours. The present inventors have discovered that it may be unnecessary to heat and reflux the ingredients for more than 10 hours during this reacting step 306, contrary to the above-incorporated U.S. Pat. No. 10,011,706.

Fourth, during step 308 of process 300, the hybrid nanoadditive is recovered. This recovering step 308 may involve filtering the reaction mixture from step 306 and collecting the hybrid nanoadditive as the filtration cake.

Finally, during step 310 of process 300, the hybrid nanoadditive is processed into a substantially uniform powder. This processing step 310 may involve drying, crushing, and/or grinding the hybrid nanoadditive. Typical particle size measurements for the powdered, hybrid nanoadditive are provided above.

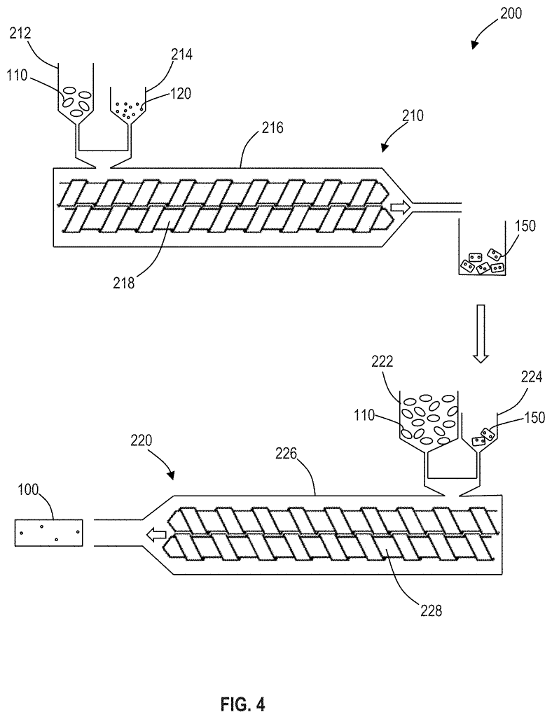

The powder from the processing step 310 may be packaged, stored, and delivered for subsequent manufacturing of the composite material 100 (FIG. 1). For example, the powder may be packaged and delivered to a manufacturing system, such as the manufacturing system 200 described below with respect to FIG. 4.

### IV. Reinforcing Filler

Returning to FIG. 1, the optional reinforcing filler 130 may be present in the polymer 110 to improve the strength and stiffness of the material 100 without adding significant weight to the material 100. Exemplary reinforcing fillers 130 include fibers, such as glass fibers, carbon fibers, and/or synthetic fibers. The reinforcing fillers 130 may be unidirectional (e.g., tapes, roving), multi-directional (e.g., woven, braided), chopped, or other forms. It is also within the scope of the present disclosure for the material 100 to be unfilled without any reinforcing fillers 130.

### V. Manufacturing System and Method

Referring next to FIG. 4, an exemplary system 200 is provided for manufacturing the material 100. The illustrated system 200 includes a first extruder 210 having a first hopper 212, a second hopper 214, one or more barrels 216, and one or more screws 218. The system 200 also includes a second extruder 220 having a first hopper 222, a second hopper 224, one or more barrels 226, and one or more screws 228. In certain embodiments, the extruders 210, 220 may be located at different manufacturing sites. In other embodiments, a single piece of equipment may be used as both extruders 210, 220 rather than using two separate pieces of equipment.

The extruders 210, 220 may be designed and operated to achieve adequate melting of the polymer 110 and dispersion of the hybrid nanoadditive 120, as described further below. For example, the barrels 216, 226, may be heated to a barrel temperature at or near the melting temperature of the polymer 110. Depending on the selected polymer 110, this barrel temperature may be 200° F., 300° F., 400° F., 500° F., or more, for example. It is understood that other energy needed to melt the polymer 110 may be generated through shear heating and/or viscous dissipation in the extruders 210, 220. Also, each extruder 210, 220 may have twin screws 218, 228, respectively, which may be rotated at speeds of 100 rpm, 200 rpm, 300 rpm, or more, for example. Advantageously and surprisingly, the operating properties used to disperse the hybrid nanoadditive 120 may be the same as or similar to the operating properties used to process the polymer 110 alone. Thus, the hybrid nanoadditive 120 may be incorporated into existing processes without significant modifications.

A multi-step manufacturing method may be performed using the system 200, as described further below.

First, the first extruder 210 is operated to produce an intermediate masterbatch 150 that compounds a high concentration of the hybrid nanoadditive 120 into the polymer 110. In this way, the masterbatch 150 contains a higher concentration of the hybrid nanoadditive 120 than the final material 100. In certain embodiments, the hybrid nanoadditive 120 may be present in the masterbatch 150 at a concentration of about 5 wt. %, about 10 wt. %, about 15 wt. %, about 20 wt. %, about 25 wt. %, or more. During this process, the polymer 110 is loaded into the first hopper 212 in the form of pellets, granules, flakes, or a powder, for example, and the hybrid nanoadditive 120 is loaded into the second hopper 214 in the form of a powder (e.g., the powder from the processing step 310 of FIG. 3). The polymer 110 and the hybrid nanoadditive 120 may be fed into the barrel 216 at a desired rate. The barrel temperature, the screw speed, and other properties of the first extruder 210 may be controlled to achieve adequate melting of the polymer 110 and dispersion of the hybrid nanoadditive 120, as noted above. The masterbatch 150 may be delivered from the first extruder 210 in the form of rods, pellets, or other suitable forms for subsequent processing. The masterbatch 150 may be packaged and sold as a commercial product. Advantageously, the masterbatch 150 may be easier to store, transport, and process than the powder hybrid nanoadditive 120 alone.

Next, the second extruder 220 is operated to produce the final material 100 that compounds a low concentration of the hybrid nanoadditive 120 into the polymer 110. Stated differently, the second extruder 220 serves to dilute the masterbatch 150 with additional polymer 110. The additional polymer 110 is loaded into the first hopper 222 in the form of pellets, granules, flakes, or a powder, for example, and the masterbatch 150 is loaded into the second hopper 224. The polymer 110 and the masterbatch 150 may be fed into the barrel 226 at a desired rate. The barrel temperature, the screw speed, and other properties of the second extruder 220 may be controlled to achieve adequate melting of the polymer 110 and dispersion of the hybrid nanoadditive 120 from the masterbatch 150, as noted above. The material 100 may be delivered from the second extruder 220 in its final shape. Alternatively, the material 100 may be re-melted and further processed (e.g., injection molded).

It is also within the scope of the present disclosure to perform a single-step manufacturing method using a single extruder (e.g., the second extruder 220). This single-step manufacturing method would omit production of the intermediate masterbatch 150. Instead, the second extruder 220 would be operated to produce the material 100 by compounding a low concentration of the hybrid nanoadditive 120 directly into the polymer 110.

The optional reinforcing filler 130 (FIG. 1) may be incorporated into the polymer 110 before, within, and/or after the extruders 210, 220. In one example, a continuous reinforcing fiber may be fed through the second extruder 220. In another example, the material 100 may be re-melted and vacuum-infused into a reinforcing fabric. Other methods for incorporating the reinforcing filler 130 into the polymer 110 include use of prepreg materials, hand layup, or spray applications, for example.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### EXAMPLES

### Example #1: Synthesis and Characterization of Hybrid Nanoadditive Comprising Functionalized Graphene Oxide and Glycidyl POSS Cage Mixture (“E-GO”)

GO-amine reaction: Approximately 100 g of GO (4 kg, 2.5% GO dispersion in water) was taken and 4 kg of distilled water added. 300 g of ethylenediamine was dissolved in 4 kg of isopropyl alcohol and added slowly into the GO dispersion and kept mixing (150 rpm) at room temperature. The mixture was stirred for 4 hours.

Recovery of GO-amine: 10.2 kg of isopropyl alcohol measured and added into the reaction mixture. The mixture was stirred for 30 minutes inside the reactor at 150 rpm and transferred into the filtration unit. Negative pressure of −35 psi was applied to remove the filtrate. The residue was collected. The residue in the form of cake was removed and re-dispersed in 3 gallons of tetrahydrofuran. The dispersion was again filtered and GO-amine cake was collected.

Reaction of GO-amine and EP0409 POSS: GO-amine cake was dispersed in 2 gallons of THF. It was mixed (150 rpm) at room temperature for 1 hour. N, N′-dicyclohexylcarbodiimide (DCC) catalyst (0.02% with respect GO; 15 mL of 0.1% in THF) measured and added into the reaction mixture. 150 g of EP0409 POSS (1.5 times of GO) was dissolved in 500 mL THF and added into the reaction mixture. Aluminum trifluoromethanesulfonate (Al-triflate) catalyst (0.02% with respect GO; 15 mL of 0.1% in THF) measured and added into the reaction mixture. The reaction mixture temperature was set to 75° C. and refluxed for 4 hours. After 4 hours, heating was stopped and reaction mixture was allowed to cool to room temperature and transferred in to filter.

Recovery of E-GO: Negative pressure of −35 psi was applied to the filter and residue was collected. The residue was dispersed in 1 gallon of THF and filtered. The E-GO cake was collected.

Drying of E-GO: The E-GO cake thus obtained was broken into pieces and spread over a metal tray. The tray was left open inside fume hood over night at room temperature. The weight of the tray was measured. The process of weighing and drying continued until no further loss in weight was observed.

Processing of E-GO Powder: The fully dried cake was placed inside a Ninja crusher and crushed for 2 minutes. The crushing process was repeated if any bigger chunks were observed. Powder form of E-GO was used to make dispersion in solid and liquid polymers.

Characterization: The resulting E-GO hybrid of GO and EP0409 POSS was determined to contain approximately 70 to 80% graphene and 20 to 30% POSS. It was black color, had light particles, and existed in powder form. It can be directly used in powder form. E-GO particle's lateral dimension is about micron (10-35 microns) and thickness is in nanometer (0.3 to 1 nm) size.

### Example #2: Dispersion of E-GO in Epoxy Resins

The E-GO of Example 1 was dispersed in a bisphenol A (BPA) epoxy resin at 0.1% concentration with respect to the resin (Part-A). Number-based particle size analysis was conducted via optical microscopy and revealed the following results.

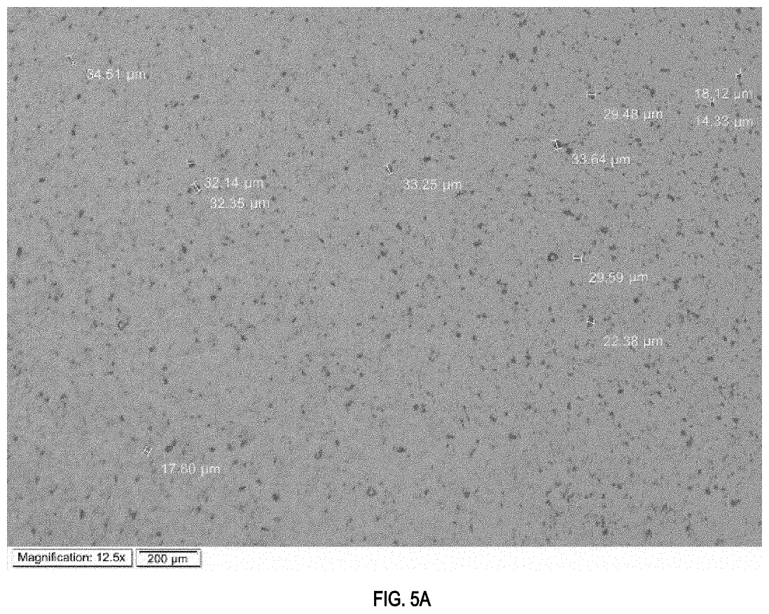

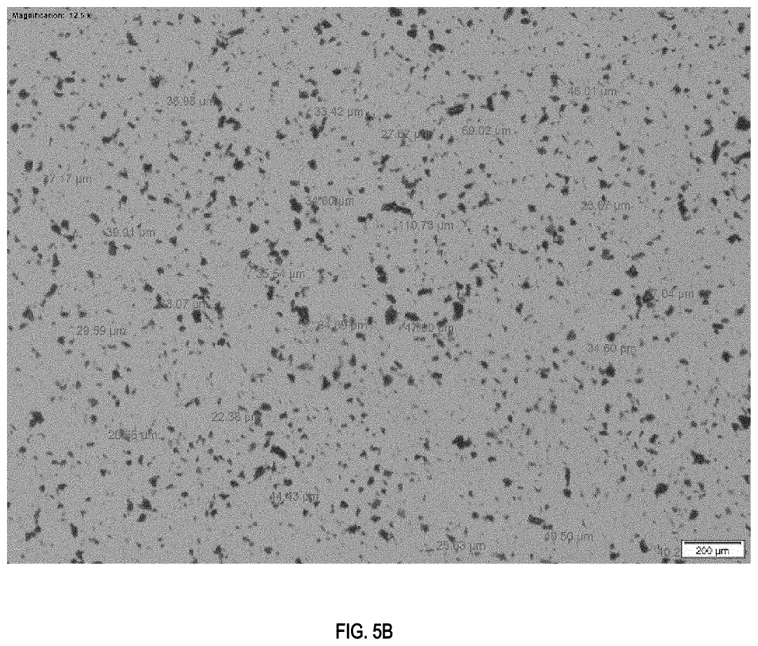

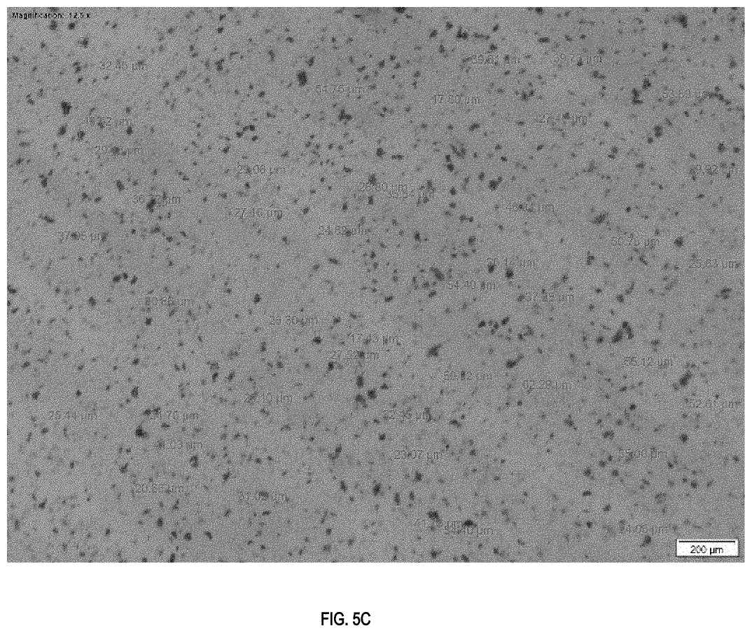

When dispersed using 3 Roll Mill as a master batch followed by dilution to 0.1% of the BPA epoxy resin, the average size of E-GO particles was found to be 29.9 microns with the range of 17.8 to 34.5 microns. The particle distribution throughout the resin media was found to be very uniform. This dispersion is shown in FIG. 5A.

With direct dispersion of dry E-GO powder the BPA epoxy resin, the particle sizes were in the range of 22.38 to 110.74 micron, particles sizes rarely exceeding the value of 65 microns. The average was found to be 40.2 microns. This dispersion is shown in FIG. 5B.

The direct dispersion of dry E-GO powder into a bisphenol F (BPF) epoxy resin also resulted in a similar uniform distribution of particles with a particle size range between 17.8 to 62.2 microns and an average value of 34.3 microns. This dispersion is shown in FIG. 5C.

The dispersion analysis shows a uniform dispersion can be achieved in most situations via simple and commercially viable dispersion techniques and the majority particle size post-dispersion in the resin system is sub-100 microns with the average values consistently Please in the sub-50 microns. It is also observed the dispersibility is stable and consistent across different predominantly available epoxy resins.

Composite test panels were fabricated using these resin systems and Harness Satin Weave (5HS) PAN Carbon Fiber and Flexural property tests were conducted according to ASTM D-790 standard test specifications. The panels made from the E-GO dispersion exhibited improved properties compared to the control panels made from neat resin. The flexural toughness and flexural strength increased by over 10%, while there was about 8% increase in flexural modulus. The increase in mechanical property can be attributed to both reinforcement to the resin matrix due to the hybrid additive as well improvement of fiber-matrix adhesion.

### Example #3: Dispersion of E-GO in Nylon

The E-GO hybrid nanoadditive of Example 1 was compounded into DuPont™ Zytel® 101 nylon 66 polymer at concentrations of 0.0 wt. % (control), 0.1 wt. %, and 0.5 wt. % via extrusion according to the conditions set forth in Table 2 below.

TABLE 2

| Condition | Value |
|---|---|
| Barrel Temperatures | Barrel #1 = 250° F. |
| | Barrels #2-14 = 500° F. |
| Polymer Feed Rate | 30 pounds/hour |
| Hybrid Nanoadditive Feed Rates | Control = 0 pounds/hour |
| | 0.1 wt. % = 0.03 pounds/hour |
| | 0.5 wt. % = 0.15 pounds/hour |
| Screw Speed | 200 rpm |
| Screw Type | Glass fiber |

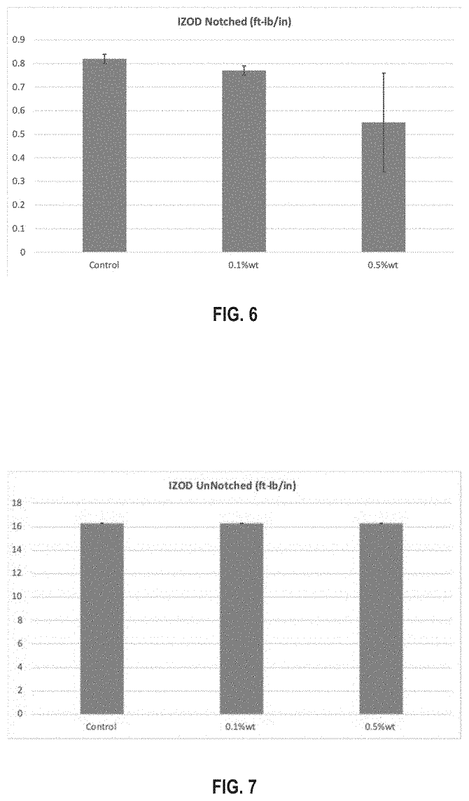

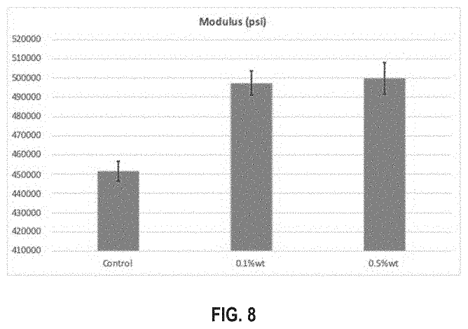

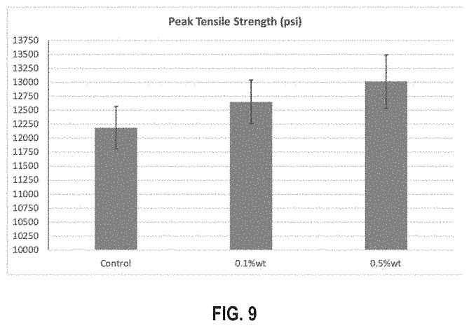

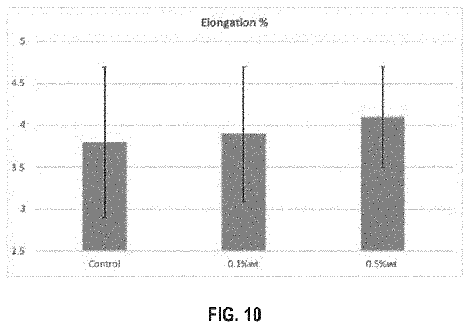

The compounded samples were subjected to mechanical testing, specifically IZOD notched impact testing in accordance with ASTM D256 (FIG. 6), IZOD unnotched impact testing in accordance with ASTM D256 (FIG. 7), tensile modulus testing (FIG. 8), tensile strength testing (FIG. 9), and tensile elongation testing (FIG. 10). With only 0.1 wt % of the hybrid nanoadditive, the tensile modulus increased by 10.2% relative to the control sample (FIG. 8), the tensile strength increased by 3.7% relative to the control sample (FIG. 9), and the tensile elongation increased by 2.6% relative to the control sample (FIG. 10). Surprisingly, however, the notched impact resistance decreased by only 6% relative to the control sample (FIG. 6), and the unnotched impact resistance remained substantially unchanged relative to the control sample (FIG. 7).

1. A composite material comprising:
a thermoplastic polymer; and
a hybrid nanoadditive including a first, graphene oxide portion and a second, polyhedral oligomeric silesquioxane (POSS) portion, wherein the hybrid nanoadditive is present in the thermoplastic polymer at a concentration of about 1.0 wt. % or less.

2. The material of claim 1, wherein the hybrid nanoadditive is present in the thermoplastic polymer at a concentration of about 0.05 wt. % to about 0.5 wt. %.

3. The material of claim 2, wherein the hybrid nanoadditive is present in the thermoplastic polymer at a concentration of about 0.1 wt. %.

4. The material of claim 1, further comprising a reinforcing filler in the thermoplastic polymer.

5. The material of claim 1, wherein the thermoplastic polymer is nylon.

6. The material of claim 1, wherein the first portion of the hybrid nanoadditive is amine-functionalized graphene oxide and the second portion of the hybrid nanoadditive is glycidyl POSS.

7. The material of claim 1, wherein the hybrid nanoadditive is compounded into the thermoplastic polymer by extrusion.

8. A method of manufacturing a composite material comprising:
extruding a thermoplastic polymer with about 1.0 wt. % or less of a hybrid nanoadditive, the hybrid nanoadditive including a first, graphene oxide portion and a second, polyhedral oligomeric silesquioxane (POSS) portion.

9. The method of claim 8, wherein the extruding step comprises:
loading the thermoplastic polymer into a first hopper; and
loading a masterbatch into a second hopper, the masterbatch comprising a high concentration of the hybrid nanoadditive compounded into the thermoplastic polymer.

10. The method of claim 9, wherein the high concentration of the hybrid nanoadditive in the masterbatch is about 5 wt. % or more.

11. A method of manufacturing a hybrid nanoadditive for use in a composite material, the method comprising:
reacting a functionalized graphene oxide with a functionalized polyhedral oligomeric silesquioxane (POSS) to form a hybrid nanoadditive; and
processing the hybrid nanoadditive into a substantially uniform powder.

12. The method of claim 11, wherein the powder has a number-based average lateral dimension of about 40 microns or less.

13. The method of claim 11, wherein the powder has a number-based average thickness of about 0.01 micron or less.

14. The method of claim 11, further comprising preparing the functionalized graphene oxide by reacting graphene oxide with a water-soluble amine.

15. The method of claim 14, wherein the water-soluble amine is selected from the group consisting of ethylene diamine, 1,3-diaminopropane, 1,4-diaminobutane, 1,5-pentanediamine, [3-(aminomethyl)phenyl] methanamine, diethylenetriamine, triethylenetetramine, and butane-1,1,4,4-tetraamine.

16. The method of claim 15, wherein the preparing step is performed at room temperature.

17. The method of claim 11, wherein the functionalized POSS comprises glycidyl POSS.

18. The method of claim 11, wherein the reacting step is performed at a temperature of about 70° C. or more for about 1 to 10 hours.

19. The method of claim 11, wherein the processing step comprises at least one of drying, crushing, and grinding the hybrid nanoadditive.

20. The method of claim 11, further comprising incorporating the powder into a masterbatch.
